(19) United States
(12) Patent Application Publication
(10) Pub. No.: US 2008/0127574 A1
(43) Pub. Date: Jun. 5, 2008

(54) SHOPPING MALL WITH VEHICLE-ACCESSIBLE ENTERTAINMENT AREA, AND METHODS OF OPERATING SAME

(76) Inventor: Chol H. Yi, Ann Arbor, MI (US)

Correspondence Address: CARRIER BLACKMAN AND ASSOCIATES, 24101 NOVI ROAD, SUITE 100, NOVI, MI, 48375, US

(21) Appl. No.: 11/949,948

(22) Filed: Dec. 4, 2007

Related U.S. Application Data
(60) Provisional application No. 60/872,300, filed on Dec. 4, 2006.

(51) Int. Cl. E04H 14/00; H04B 14/00; E04H 3/10

(52) U.S. Cl. 52/8; 381/78; 52/174; 52/741.1

(57) ABSTRACT

A shopping mall combined with an entertainment facility includes a drive-in area with a large video display screen adapted to provide visibility of images displayed thereon during daylight hours. A centralized parking lot has a multiplicity of parking spaces oriented towards the screen, and retail stores are situated adjacent edge portions of the centralized parking lot. When entertainment is projected on the screen, a transmitter sends corresponding audio signals to audio receivers in cars parked in the lot. The retail stores are in a number of interconnected buildings, arranged substantially in a U-shape, which may also include offices, residential suites, hotels, or other functional uses. The large screen is situated inside a central portion of the profile. Optionally, a cruising track may surround the centralized parking lot. The mall may also include a restaurant, fueling station and/or a decorative arrangement aligned with the large screen.

### CROSS-REFERENCE TO RELATED APPLICATIONS

The present application claims priority benefit under 35 USC § 119 of U.S. Provisional Patent Application No. 60/872,300, filed on Dec. 4, 2006. The entire subject matter of this priority document is incorporated by reference herein.

### BACKGROUND OF THE INVENTION

1. Field of the Invention

The present invention relates to a shopping mall with a central vehicle-accessible parking lot providing access to entertainment area, including a video display system which may be used as a drive-in movie theater. The central lot may include a cruising track. More particularly, the present invention relates to a shopping mall which incorporates a drive-in video display system, and may also include a stage for live shows, and a centralized parking lot inside the mall operatively associated with the video display and live show system.

2. Description of the Background Art

There are many known shopping malls and/or drive-in theaters, and combinations thereof. Some known shopping malls and/or drive-in theaters are illustrated in U.S. Pat. No. 2,831,217 (Lombardo); 2,895,179 (Wilson), 4,075,795 (Thomas), 4,653,240 (Jenn); 5,775,033 (Meehan); 6,115,974 (Milanian); and 6,164,018 (Runge et al.).

Although the known shopping malls and drive-in movie theaters are useful for their intended purposes, a need still exists in the art for a new combined shopping mall and drive-in theater. In particular, there is a need for an improved shopping mall having a vehicle-accessible entertainment area with an enlarged video display screen, and method of video display using such arrangement.

### SUMMARY OF THE INVENTION

Accordingly, in a first embodiment hereof, the present invention provides a shopping mall combined with a drive-in theater and entertaining and advertising systems. The shopping mall may be an indoor or an outdoor mall.

The shopping mall, according to the first embodiment, includes a large screen adapted to provide visibility of images displayed thereon during daylight hours, a centralized parking lot having a multiplicity of parking spaces oriented towards the screen, a plurality of retail stores situated adjacent edge portions of the centralized parking lot, and a transmitter for transmitting coordinated audio signals to audio receivers held by users of the mall.

The large screen is dimensioned such that a person with normal eyesight is able to see the images displayed on the screen during daylight and also during nighttime. The size of the screen may be proportionate to the dimensions, e.g., width and length of the centralized parking lot. The large screen is also referred as a display screen. The large screen may have the capability to function as a jumbo television set. The screen may have aspect ratio one of 16:9, 4:3 and 2.35:1. With an aspect ratio of 16:9, as an example, the screen size may be 64 feet wide by 36 feet high. With an aspect ratio of 4:3, for example, the screen size may be 80 feet wide and 60 feet high. However, the width of the screen should be at least 10 feet.

The screen may use available technologies, such as liquid crystal display (LCD), plasma display panel (PDP), Digital Light Processing (DLP), or projection displays using one of these techniques or combination thereof, to display the images on screen which are seen during daylight.

The centralized parking lot may include a plurality of parking zones, each having multiple parking spaces oriented toward the large screen. The centralized parking lot may have an oval-shaped, a circular-shaped, a rectangular-shaped, a square-shaped, or any other suitable shaped profile. The centralized parking lot may generally formed on a substantially, flat, planar ground surface. Alternatively, if desired, the centralized lot may be oriented inclining downwardly from a high point at a distal thereof opposite the display screen, to a low point at a proximal end thereof near the display screen, in order to provide easy visibility of the display screen from the vehicles parked therein.

The centralized parking lot is a multipurpose lot. In other words, the centralized parking lot may be used as an event arena such as for trade shows including auto exhibitions, community picnics, festivity, etc, when it is not used as parking lot. Alternatively, a portion of the centralized parking lot may be used for organizing events.

The retail stores are situated adjacent edge portions of the centralized parking lot, and are housed in a plurality of interconnected buildings arranged around the centralized parking lot in a substantially U-shaped profile. The interconnected buildings may also house offices, residential suites (e.g., condominiums, apartments), hotels, workout facilities, clubs, etc.

The transmitter transmits audio signals at specified frequencies in real time corresponding to images displayed on the display screen to audio receivers carried by the users of the mall. The audio signals, which may be radio signals, may be digital or analog signals. The transmitter also transmits the audio signals to audio receivers of vehicles parked in the centralized parking lot. The audio transmission can also be done to the hotel rooms/condos/apartments and restaurants/bars/cafes throughout the mall. This may be done via radios or speaker systems throughout the mall. For example, a person staying at the hotel or living in a condo can watch the movie from their balcony and get the sound through their stereos in the room. People watching from restaurants/bars/cafes can also listen though stereos or speakers placed in those areas.

The present invention, according to a second embodiment thereof, provides an overhanging roof extending from one end of the centralized parking to the other end thereof. The overhanging roof may be made of transparent material to facilitate lighting of the parking lot via natural daylight. The roof provides protection from wind, snow, rain, and heat from sunlight.

Alternatively, only the interconnected buildings may be provided with an overhanging roof, and the centralized parking lot may be open to the air and uncovered. Vehicular access to the centralized lot may be restricted by gates or by other security screening arrangements.

According to a third embodiment hereof, the central parking lot may be provided with one or more drivable tracks, e.g., cruising tracks situated around the periphery of the lot. Optionally, the drivable tracks may be extended beyond the centralized parking lot.

According to a fourth embodiment thereof, a stage platform may be situated below the large screen. Such platform may used as a stage for performing arts such as theater or musical concerts, as a podium/dais for community speeches, or for demonstrating products, etc.

According to a fifth embodiment hereof, the present invention provides one or more of a restaurant, a fueling station and/or a decorative arrangement, in addition to the features of the first through fourth embodiments. The decorative arrangement is an optional feature of the present invention. The restaurant, the decorative arrangement, and the fueling station may be aligned with the large screen. The decorative arrangement may be situated between the centralized parking lot and the restaurant. The fueling station may be situated adjacent to the restaurant such that the restaurant is located between the fueling station and the decorative arrangement or the centralized parking lot.

According to a sixth embodiment hereof, the present invention provides a method of video display using the shopping mall, as discussed above, by displaying video images. The method of video display to mall patrons includes the steps of providing a large screen adapted to provide visibility of images displayed thereon during daylight hours; assembling cars in a centralized parking lot having a multiplicity of parking spaces therein which are oriented facing toward the screen; displaying video images on the large screen to occupants of assembled cars; and transmitting audio signals to cars parked in the centralized parking lot to correspond in real time to video images displayed on the screen.

According to a seventh embodiment thereof, the present invention provides a method of live entertainment using the shopping mall, as discussed above, via live performance. Such method of entertaining mall patrons via live performance includes the steps of providing a platform; assembling cars in a centralized parking lot having a multiplicity of parking spaces therein which are oriented facing toward the platform; displaying live entertainment on the platform to occupants of assembled cars; transmitting audio signals to cars parked in the centralized parking lot to correspond in real time to the live entertainment taking place on the platform.

For a more complete understanding of the present invention of the shopping mall and drive-in theater combination, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a front perspective view of a shopping mall with a video display system (usable as a drive-in theater) according to an illustrative embodiment of the present invention.

FIG. 2 is a rear perspective view of the shopping mall and video display system of FIG. 1.

FIG. 3 is an elevational view of a central portion of the shopping mall of FIG. 1; and

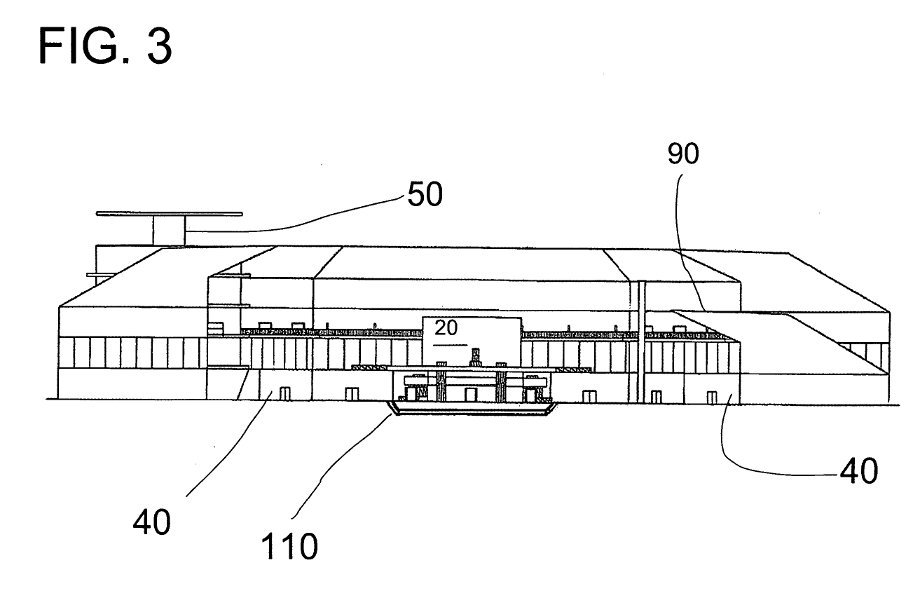

FIG. 4 is a top plan view of the shopping mall of FIG. 1.

### DETAILED DESCRIPTION OF ILLUSTRATIVE EMBODIMENTS

It should be understood that only structures and methodology considered necessary for clarifying the selected illustrative embodiments of the present invention are described herein. Other conventional structures, and those of ancillary and auxiliary components of the system, will be known and understood by those skilled in the art.

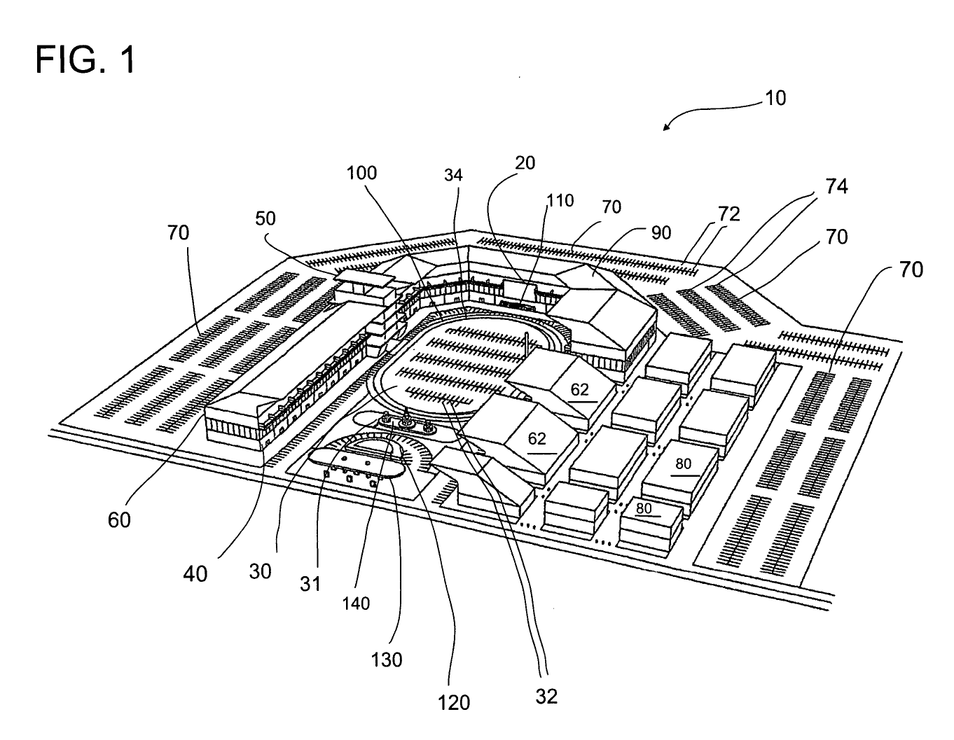

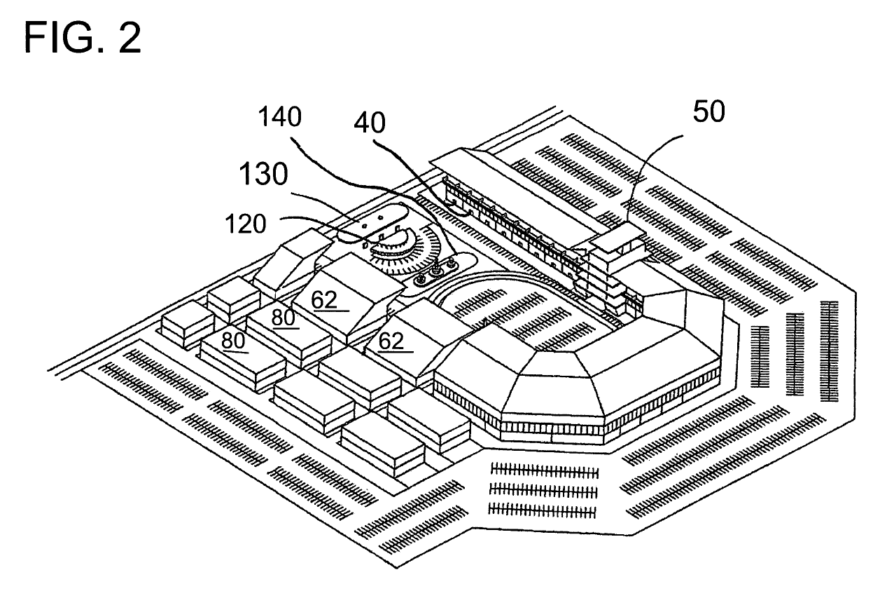

With specific reference to the drawings, and in particular to FIGS. 1 and 2 thereof, a shopping mall, i.e., combination of the shopping mall and video display system including drive-in theater according to a first illustrative embodiment of the present invention, is designated by the reference numeral 10. This will be referred to herein as the mall 10. It is contemplated that the mall 10 hereof may be constructed around a specific selected theme such as, e.g., automobiles, vacation islands, space exploration, movie trivia, or other selected theme.

As shown in FIGS. 1 and 2, the combination of the shopping mall and video display system, according to an illustrative embodiment, generally includes a large screen 20 adapted to provide visibility of images displayed thereon during daylight hours. The mall 10 includes a centralized vehicle-accessible parking lot 30 having a multiplicity of parking spaces 32 generally oriented towards the screen 20, and a plurality of retail stores 40 situated adjacent edge portions of the centralized parking lot 30, The mall 10 also includes a transmitter 50 which transmits audio signals to audio receivers (not shown) carried by the users of the mall 10.

The large display screen 20 is dimensioned such that a person with normal eyesight is able to see the images displayed on the screen during daylight and also at night. The size of the screen 20 may be proportionate to the dimensions, e.g., width and length of the centralized parking lot 30. The large screen 20 is also referred as a display screen. The large screen 20 may, optionally, be capable of operating as a jumbo television (TV) set. The screen 20 may have one of an aspect ratio of 16:9, 4:3 and 2.35:1. For an aspect ration of 16:9, as an example, the screen size may be at least 10 feet wide.

The screen 20 may use available technologies, such as liquid crystal display (LCD), plasma display panel (PDP), Digital Light Processing (DLP), or projection displays using one of these techniques or combination thereof, to display the images during daylight hours and during night time. A projector (not shown) may be used to project images on the screen 20.

It is desirable that the images displaced on the screen 20 are visible during daylight. Multiple smaller screens may be combined to form a display screen 20 of the required size. Other techniques, such as one or more blank white panels, may be used as a display screen if images are projected thereon.

The centralized parking lot 30 may include a plurality of parking zones 31, each having multiple parking spaces 32 therein, where vehicles may be parked with the windshield oriented toward the large screen 20. The centralized parking lot 30 may have oval-shaped, a circular-shaped, a rectangular-shaped, a square-shaped, or any other suitable shaped profile, a combination thereof. The centralized parking lot 20 may be generally formed on a substantially, flat, planar ground surface. Alternatively, if desired, the centralized lot may be oriented on a slope, inclining gradually downwardly from a high point at a distal thereof opposite the display screen, to a low point at a proximal end thereof near the display screen, in order to provide easy visibility of the display screen from the vehicles parked therein. Where a sloped parking lot is used, the lot may be made slightly concave or bowl-shaped, if desired. Vehicular access to the centralized lot 30 may be restricted by gates at the open end of the U-shaped building arrangement, or by other security screening arrangements.

According to an embodiment of the present invention, the centralized parking lot 30 is a multipurpose lot. In other words, the centralized parking lot 20 may be used as an event arena such as for trade shows including auto exhibitions, community picnics, festivity events, sporting events, etc.

The plurality of retail stores 40 (also referred as outlets) is situated adjacent edge portions of the centralized parking lot 30. However, in an embodiment of the present invention, the retail stores 40 may be situated away form the edge portion 34 of the centralized parking lot 30. The retail stores 40 may be housed in a plurality of interconnected buildings 60 arranged around the centralized parking lot 30 in a substantial in a U-shaped profile or a horseshoe-shaped profile. The interconnected buildings 60 may also house other commercial or residential space such as offices, residential suites (e.g., condominiums, apartments), hotels, fitness centers, clubs, or the like.

The buildings 60 may be multistory/multi-floor buildings in which a first (ground) floor may be used as space for retail stores 40, a second floor can be used for additional retail space or as a office space, a third and subsequent floors may be used for office suites, educational institutes, residential suites including condominiums and apartments, hotels, clubs, etc. The buildings 60 are not required to include an equal number of floors. That is, some buildings may have a single floor while other buildings may have two or more floors.

A plurality of additional satellite parking lots 70 may be provided around an outside portion of the interconnected buildings 60, i.e., around an outside portion of the U-shaped profile of the buildings 60. Such additional parking lots 70 include multiple parking spaces 72 or multiple parking zones 74. The additional parking lots 70 may include mall-patron parking lots, office parking lots, residential parking lots, hotel parking lots, club parking lots, etc.

A plurality of passages 80, e.g., alley streets 80 may be provided in between the interconnected buildings for facilitating movement of cars and mall-patrons between the plurality of additional parking lots 70 and the centralized parking lot 30 and/or retail stores 40. Such passages 80, where used, may include sidewalks.

In an embodiment of the present invention, the buildings housing the retail outlets may not be interconnected, i.e., individual buildings 62 may be arranged separate from each other. Such individual buildings 62 are arranged in a substantially U-shaped or a horse-shoe shaped profile. When the buildings are not connected, they provide a plurality of passages between the outside parking and the centralized parking lot, and/or retail stores 40.

The transmitter 50 of the present invention transmits audio signals, at specified frequencies in real time corresponding to the images displayed by the large screen 20, to audio receivers (not shown) carried by mall patrons. The audio signals may be digital or analog signals. The transmitter may also transmit the audio signals to the audio receivers of the vehicles parked in the centralized parking lot 30. Optionally, if desired, the transmitter may also transmit the audio signals to vehicles in the parking lots 70 situated outside the interconnected buildings 60 and/or individual buildings 62.

The audio signals may also be transmitted to the hotel rooms, condos/apartments and restaurants, bars, and/or cafes throughout the mall. This may be done via radios or speaker systems throughout the mall. For example, a person staying at the hotel or living in a condo can watch the movie from their balcony and get the sound through their stereos in the room. People watching from restaurants/bars/cafes can also listen though stereos or speakers placed in those areas.

The specified frequencies at which the transmitter transmits audio signal may include Amplitude Modulation frequencies, e.g., electromagnetic waves with frequencies between 535 kHz and 1605 kHz. Further, the specified audio frequencies may include Frequency Modulation frequencies, e.g, electromagnetic waves with frequencies between 88 mHz and 108 mHz. The transmitter is also capable of transmitting audio signals at higher frequency, e.g., between 1.55 GHz and 5.2 Ghz. Other frequencies known to those in the art, and suitable for short-range communication, may also be used to transmit the audio signals. The audio signals may be transmitted at frequencies which may be picked up by conventional car radios. Alternately, if desired, customers may be provided with customized receiver units which may be returned after each performance, to limit the users allowed to receive the audio signals.

Further, the present invention, according to a second embodiment thereof, provides an overhanging roof 90 extending from one or more of the interconnected buildings 60 towards the centralized parking lot 30. If desired, it is also possible to provide an overhanging roof extending from one end of the centralized parking 30 to the other end thereof. The overhanging roof 90 may be made of transparent material to facilitate lighting of the centralized parking lot 30 during natural daylight. The overhanging roof 90, where used, provides protection from wind, snow, rain, and heat from sunlight.

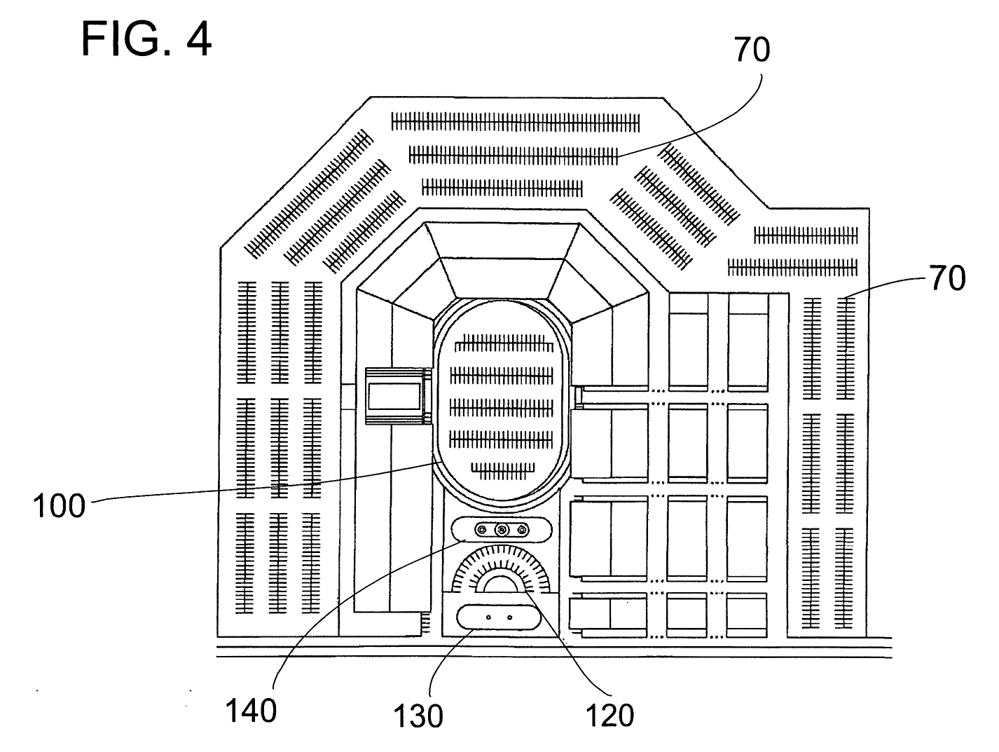

As shown in FIGS. 1 and 4, the present invention according to a third embodiment thereof, provides one or more drivable tracks 100 such as e.g., cruising tracks, situated around the perimeter of the centralized parking lot 30. The drivable tracks 100 may be extended beyond the centralized parking lot 30. The shape of the driving tracks 100 depends upon the shape of the centralized parking lot. For example, if the centralized parking lot 30 is oval-shaped, then the drivable tracks 100 are also oval-shaped.

The present invention, according to a fourth embodiment thereof, provides a platform 110 situated below the large screen 20. Such platform 110 may used as an artist's stage, as a stage for live performances such as theater or musical concerts, as a podium/dais for community speeches, etc. Alternatively, the platform 110 may be used for new product display, such as a display of one or more automobiles, outdoor play sets, etc.

As shown in FIGS. 1, 2 and 4, the present invention, according to a fifth embodiment thereof, provides a restaurant 120, a fueling station 130 and/or an optional decorative arrangement 140. An example of the restaurant 120 includes an old-style “drive-in” type diner having a substantially semicircular shape, as shown. The restaurant 120 has least one row of multiple automobile parking spaces located around an outer portion thereof. As shown in FIG. 4, in an old-style semicircular-shaped diner, rows of multiple automobile parking spaces are formed around a curved portion thereof. The restaurant 120 may be situated adjacent the decorative arrangement 140.

The decorative arrangement 140, where used, may be situated between the centralized parking lot 30 and the restaurant 120. The decorative arrangement 140 may include water fountains, architectural designs, gardens, etc. During the winter months in cold climates, the decorative arrangement could be converted into a skating rink.

The fueling station 130, where used, may be situated adjacent to the restaurant 120.

The restaurant 120, the decorative arrangement 140, and/or the fueling station 130 may be aligned with the display screen 20.

The present invention, according to a sixth embodiment thereof, provides a method of video display using the shopping mall 10, as discussed above, by displaying video images. The method of video display to mall patrons includes the steps of: providing a large screen 20 adapted to provide visibility of images displayed thereon during daylight hours; assembling cars in a centralized parking lot 30 having a multiplicity of parking spaces therein which are oriented facing toward the screen; displaying entertainment/advertisement images on the large screen 20 to occupants of assembled cars; transmitting audio signals to cars parked in the centralized parking lot to correspond in real time to video images displayed on the screen.

The present invention, according to a seventh embodiment thereof, provides a method of live entertaining using the shopping mall, as discussed above, via live performance. Such method of entertaining mall patrons via live performance includes the steps of providing a platform 110; assembling cars in a centralized parking lot 30 having a multiplicity of parking spaces therein which are oriented facing toward the platform; displaying in person entertainment images on the platform to occupants of assembled cars; transmitting audio signals to cars parked in the centralized parking lot 30 to correspond in real time to live shows, in person, displayed on the platform.

### ADVANTAGES OF THE PRESENT INVENTION

It may be noted that the future holds many uncertainties for brick-and-mortar retailers as more people utilize the Internet for their shopping needs. It may be predicted that, in the next 10 to 15 years, current college and high school students will become primary spenders and innovative methods are needed to bring shoppers in, keep them there longer and make them want to come back.

In the next generation of shopping malls, it may be required to provide shopping mall owners the ability to significantly raise additional revenues through convention business, hotel business and selling advertisements, and sponsorships. In one illustrative embodiment hereof, a shopping mall 10 according to the present invention, as discussed above in detail herein, provides for at least five of the passions of American consumers: shopping, automobiles, watching TV/movies, eating and entertainment. The entertainment may be free to the consumer if paid for by sponsors and advertisers.

Some useful features of the shopping mall, in the depicted embodiment include: (1) a U-shaped (or horse-shoe-shaped) shopping mall which provides easy access to retail outlets; (2) an automobile theme park atmosphere designed to resemble a NASCAR® racetrack that may be fun, exciting and nostalgic for many mall patrons; (3) a drive-in theater to show movies, sporting events, and ads which may be entertaining to consumers; (4) a driving track for consumers to cruise and test drive cars; (5) a restaurant, old style diner where car enthusiasts may gather for snacks and meals; (6) the centralized parking lot which may be used as an arena/convention center inside the shopping mall; (7) mix-use retail, office and condo or hotel to give it a coliseum feel; (8) an overhanging roof(s) to provide comfort from sun and rain; (9) Lawn, grass area for picnics or watching movies; (10) water fountain, skating rink combination for entertainment; and (11) children's play area which may be an automotive or other mall-related theme.

There may be several benefits to the shopping center owner and operator because the shopping mall, as discussed above, could be a true destination mall. The themed mall will bring people in and may be able to entertain them for free. Such entertainment will keep them there longer and encourage them to come back, resulting in higher foot traffic and sales. The specific features of the themed mall those may get people to return may include showing free movies, sporting events, etc., on the display screen (jumbo TV) and host events, conventions (auto show, new car intro, golf lessons, ice skating, etc., creating a gathering place for car enthusiasts; providing an atmosphere that is conducive to auto buffs (auto track, old-fashioned diner, themed movies, auto events, etc.); introducing new car models which can be test driven by consumers on the drivable, cruising track; some family members watching shows on the large screen, while other members of the family go shopping; and families are more likely to come to the themed mall discussed above compared to conventional malls, because the themed mall meets the requirements of shopping as well as providing entertainment.

The shopping mall, as discussed above, can be a great venue for advertising. The shopping mall is likely to allow the owners to generate additional revenues through advertisements and/or sponsorships.

The shopping mall 10 as described herein could compete against internet shopping since people will want to come to the shopping mall for shopping, dining, and entertainment.

It is also possible to somewhat control customer make-up, e.g., mall patrons. To some degree, the consumer make-up of the mall can be controlled by the types of events held, and types of movies and TV programs shown. Based on this, retailers can modify their sales to accommodate requirements of the mall patrons.

Although the present invention has been described herein with respect to a number of specific illustrative embodiments, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention.

What is claimed is:

1. In combination, a shopping mall and a drive-in theater, comprising:
a large display screen adapted to provide visibility of images displayed thereon during daylight hours;
a centralized parking lot having a multiplicity of parking spaces therein which are oriented so that vehicles may be parked therein facing toward the display screen;
a plurality of retail stores situated adjacent edge portions of the centralized parking lot; and
a transmitter for sending audio signals to cars parked in said parking lot, where said audio signals correspond in real time to video images displayed on said screen.

2. A shopping mall and a drive-in theater according to claim 1, wherein said transmitter transmits audio signals at predetermined frequencies to audio receivers of said cars.

3. A shopping mall and a drive-in theater according to claim 1, wherein the shopping mall has a generally automotive theme.

4. A shopping mall and a drive-in theater according to claim 1, wherein said large display screen is at least 20 feet wide.

5. A shopping mall and a drive-in theater according to claim 1, further comprising a drivable track extending around the perimeter of the centralized parking lot.

6. A shopping mall and a drive-in theater according to claim 1, further comprising a restaurant located at one end of the centralized parking lot, wherein one side of said restaurant faces toward the large screen.

7. A shopping mall and a drive-in theater according to claim 1, further comprising a stage platform situated below said screen.

8. A shopping mall and a drive-in theater according to claim 1, wherein said plurality of retail stores are housed in buildings arranged substantially in a U-shaped profile around the centralized parking lot.

9. A shopping mall comprising:
a plurality of interconnected buildings arranged in a substantially U-shaped profile; said U-shaped profile having a pair of side portions, and a central portion extending between said side portions;
a large display screen situated adjacent and inside the central portion of the U-shaped profile; said large display screen adapted to provide visibility of images displayed thereon during daylight hours;
a platform situated below said display screen;
a transmitter which transmits audio signals in real time corresponding to video images displayed on said display screen; and
a centralized parking lot surrounded by the U-shaped profile; said parking lot having a first end portion and a second end portion.

10. A shopping mall according to claim 9, further comprising:
a decorative arrangement situated towards the second end portion of the centralized parking lot;
a restaurant situated adjacent the decorative arrangement;
a fueling station situated adjacent the restaurant;
a plurality of parking lots formed around an outside portion of the U-shaped profile; each of said plurality of parking lots having multiple automobile parking spaces; and
a plurality of passages formed in between the interconnected buildings; said plurality of passages providing access between said plurality of parking lots formed around said outside portion of the U-shaped profile and said centralized parking lot;
wherein said central portion of the U-shaped profile, said large display screen, said centralized parking lot, said restaurant and said fueling station are substantially aligned with one another.

11. A shopping mall according to claim 9, further comprising at least one row of automobile parking spaces disposed inside of the U-shaped profile.

12. A shopping mall according to claim 9, further comprising an overhanging roof extending from said plurality of interconnected buildings toward the centralized parking lot; and wherein said interconnected buildings are multi-floor buildings.

13. A shopping mall according to claim 9, wherein said centralized parking lot includes a multiplicity of automobile parking spaces therein which are oriented such that vehicles may be parked therein facing toward said large display screen.

14. A shopping mall according to claim 9, wherein said transmitter transmits audio signals at specified frequencies corresponding to audio receivers carried by persons using the mall.

15. A method of video display in a shopping mall comprising a centralized parking lot and a plurality of retail stores situated adjacent edge portions of said centralized parking lot; said method comprising the steps of:
providing a large screen adapted to provide visibility of images displayed thereon during daylight hours;
assembling cars along with occupants in the centralized parking lot;
displaying entertainment/advertisement images on the large screen to the occupants of assembled cars; and
transmitting audio signals to cars parked in the centralized parking lot to correspond in real time to video images displayed on the screen;
wherein said centralized parking lot includes a multiplicity of parking spaces therein which are oriented facing toward the screen.

16. A method of video display in a shopping mall according to claim 15, wherein said themed mall further comprises a restaurant situated at one end portion of the centralized parking lot.

17. A method of video display in a shopping mall according to claim 15, wherein said transmitter further transmits audio signals at specified frequencies to audio receiver carried by persons using the shopping mall.

18. A method of video display in a shopping mall according to claim 15, wherein said centralized parking lot has a substantially oval-shaped profile; and wherein said screen has an aspect ratio of one of 16:9, 4:3 and 2.35:1 and has a width of at least 20 feet.

19. A method of video display in a shopping mall according to claim 15, wherein said retail stores are housed in a plurality of interconnected buildings arranged in a substantially U-shaped profile around the centralized parking lot.

20. A method of video display in a shopping mall according to claim 19, wherein said plurality of interconnected building are further adapted to house one or more of offices, residential units, and hotels.
